(19) United States
(12) Patent Application Publication
(10) Pub. No.: US 2011/0307298 A1
(43) Pub. Date: Dec. 15, 2011

(54) EVALUATING FINANCIAL RETURNS ON SYNDICATION INVESTMENTS

(75) Inventor: David Russ, Fort Lauderdale, FL (US)

(73) Assignee: CORAL RIDGE MINISTRIES MEDIA, INC., Fort Lauderdale, FL (US)

(21) Appl. No.: 13/159,898

(22) Filed: Jun. 14, 2011

Related U.S. Application Data
(60) Provisional application No. 61/354,886, filed on Jun. 15, 2010.

(51) Int. Cl. G06Q 10/00

(52) U.S. Cl. 705/7.33; 705/7.29; 705/7.11

(57) ABSTRACT

Systems, methods, and associated software for evaluating financial performance of syndication investments (or other advertising or marketing investments) are provided. A financial performance evaluating system, according to one implementation, includes a first analyzing module configured to determine an organization's donor income from donors within a designated market area. The financial performance evaluating system also includes a second analyzing module configured to determine the programming cost to air programs in the designated market area. From these, a processing module is configured to calculate one or more financial metrics based at least on the donor income and programming cost.

### CROSS-REFERENCE TO RELATED APPLICATIONS

This application claims the benefit of U.S. Provisional Application No. 61/354,886, filed Jun. 15, 2010, the entire disclosure of which is hereby incorporated by reference herein.

### TECHNICAL FIELD

The present disclosure generally relates to syndication of broadcast programs, and more particularly relates to evaluating financial returns on syndication investments.

### BACKGROUND

Media production companies often purchase air time from various television and radio outlets to air their programs. One question in this process is whether or not each outlet that a media production company purchases is worth keeping. Different organizations have different goals. One type of analysis may be focused around financial goals, namely whether a media outlet is producing a sufficient financial return on the investment.

Some organizations, such as non-profit corporations, may have programs that seek to attract new donors (e.g., ministry partners). A few considerations in this context are (a) whether one particular media outlet is attracting enough new donors; (b) the relative value of the donors that were attracted by that media outlet (in other words, what are the demographic characteristics and are they more likely or less likely to give); and (c) whether the quantity and level of giving of these new donors justify the cost.

Financially speaking, it may be in the best interest of a media production company over time to cancel lower-performing outlets and invest in higher-performing outlets. This same analysis may also be beneficial to for-profit entities as to whether each outlet is attracting customers (instead of donors).

### SUMMARY

The present disclosure describes systems, methods, and computer-readable media for evaluating the financial performance of an organization based on the organization syndication investments. According to one implementation, a system for evaluating financial performance includes a first analyzing module configured to determine an organization's donor income from donors within a designated market area. The financial performance evaluating system also includes a second analyzing module configured to determine the programming cost to air programs in the designated market area. The system also includes a processing module, which is configured to calculate one or more financial metrics based at least on the donor income and programming cost.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a block diagram of a computer system configured to evaluate financial returns on syndication investments, according to various implementations of the present disclosure.

FIG. 2 is a block diagram of a financial performance evaluating system, according to various implementations of the present disclosure.

FIG. 3 is a graph showing a number of donors and stations with respect to a number of years being aired on the stations, according to various implementations of the present disclosure.

FIG. 4 is a graph showing income from donors with respect to years aired on the stations, according to various implementations of the present disclosure.

FIG. 5 is a graph showing breakeven information with respect to various broadcast stations, according to various implementations of the present disclosure.

FIG. 6 is a graph showing donor income and syndication cost with respect to broadcasting time slots, according to various implementations of the present disclosure.

FIG. 7 is a flow diagram illustrating a method for evaluating financial performance of syndication markets, according to various implementations of the present disclosure.

FIG. 8 is a flow diagram illustrating a method for tagging incoming donations, according to various implementations of the present disclosure.

FIG. 9 is a flow diagram illustrating a method for extracting donation data from donor transactions, according to various implementations of the present disclosure.

FIG. 10 is a flow diagram illustrating a method for processing donation data into metrics, according to various implementations of the present disclosure.

### DETAILED DESCRIPTION

The present disclosure describes systems and methods that allow media production companies to capture information for measuring financial performance. The captured information may then be analyzed to determine if syndication expenses result in profitable returns. The financial results may help executives of the media production companies make specific decisions about how syndication expenses should be directed, where to look for reductions, and when to discontinue syndication in certain areas.

Although various implementations of the present disclosure describe processes that may be used by non-profit organizations, the processes may also be used by any type of non-profit or for-profit organization, enterprise, company, business, entity, or other group wishing to evaluate financial performance. In addition, although various implementations herein describe the evaluation of financial returns with respect to expenses attributed to syndication, returns may also be evaluated based on other types of expenses, such as expenses attributed to marketing, soliciting, advertising, or other activities intended to produce financial returns. Furthermore, although various implementations herein describe the distribution of information via broadcast media (e.g., television and radio), the processes may also include distributing information through other various media outlets, webcasts, broadcast and/or multicast outlets, newspapers, magazines, printed publications, billboards, and other forms of media. Other features and advantages will be apparent to one of ordinary skill in the art upon consideration of the general principles described herein, and all such features and advantages are intended to be included in the present disclosure.

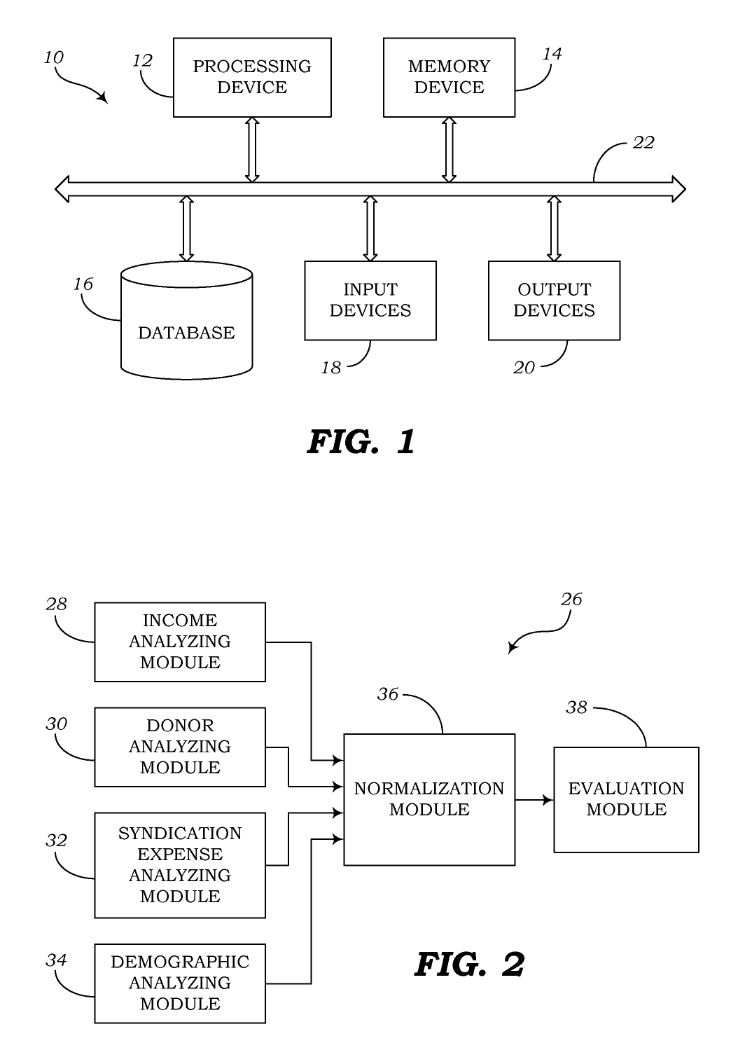

FIG. 1 is a block diagram showing an embodiment of a computer system 10 that is configured to evaluate financial performance as a result of syndication expenses. In this embodiment, the computer system 10 includes a processing device 12, a memory device 14, a database 16, input devices 18, and output devices 20. The components of the computer system 10 may be interconnected via a bus interface 22.

In some embodiments, the memory device 14 may store a software program having logic for evaluating financial performance and the processing device 12 may be configured to execute the financial performance evaluation program. In other embodiments, the processing device 12 may comprise logic components for evaluating financial performance of syndication investments. Whether configured in hardware, software, and/or firmware, the systems and methods of evaluating financial performance due to syndication expenses as described in the present disclosure are referred to herein as “financial performance evaluating systems.”

The financial performance evaluating systems are configured to receive information regarding income that the organization receives from donors and are further configured to receive demographic information. The income information and demographic information may be received via the input devices 18 or by other means. The financial performance evaluating systems are also configured to receive information regarding the expenses involved with syndication. Syndication expense information may also be received via the input devices 18 or by other means. The database 16 may be configured to store the information regarding donor income, syndication expenses, and demographics. From this information, the financial performance evaluating systems may analyze the information to determine whether the syndication expenses are warranted in the various outlets. If certain outlets are especially profitable, decisions may be made to maintain or increase expenses in those markets. Otherwise, if certain outlets are not profitable, decisions may be made to decrease or eliminate expenses in those markets.

The financial performance evaluating systems may include logical instructions, commands, and/or code for evaluating financial performance indicators (e.g., Return on Investment, or ROI) based on an organization's syndication investment. The financial performance evaluating systems may be implemented in hardware, software, firmware, or any combinations thereof. In some embodiments, the financial performance evaluating systems may be implemented in software or firmware that is stored on the memory device 14 and that is executable by a suitable instruction execution system (e.g., the processing device 12). If implemented in hardware, the financial performance evaluating systems may be embodied in the processing device 12 using discrete logic circuitry, an application specific integrated circuit (ASIC), a programmable gate array (PGA), a field programmable gate array (FPGA), or any combinations thereof.

The processing device 12 may be a general-purpose or specific-purpose processor or microcontroller for controlling the operations and functions of the computer system 10. In some implementations, the processing device 12 may include a plurality of processors for performing different functions within the computer system 10 according to various designs. The memory device 14 may include one or more internally fixed, removable, and/or remotely accessible storage units, each including a tangible storage medium. The memory device 14, which may include any combination of volatile memory and non-volatile memory, may be configured to store any combination of information, data, instructions, software code, etc.

The input devices 18 may include various input mechanisms or data entry devices, such as keyboards, keypads, buttons, switches, touch pads, touch screens, cursor control devices, computer mice, stylus-receptive components, voice-activated mechanisms, microphones, cameras, infrared sensors, or other input devices. The output devices 20 may include various output mechanisms or data output devices, such as computer monitors, display screens, touch screens, speakers, buzzers, alarms, notification devices, lights, light emitting diodes, liquid crystal displays, visual display devices, audio output devices, or other output devices. In some embodiments, the input devices 18 and output devices 20 may include input/output devices that are configured to receive input and provide output, such as interaction devices, dongles, touch screen devices, and other input/output devices.

FIG. 2 is a block diagram illustrating an embodiment of a financial performance evaluating system 26. In this embodiment, the financial performance evaluating system 26 includes an income analyzing module 28, a donor analyzing module 30, a syndication expense analyzing module 32, a demographic analyzing module 34, a normalization module 36, and an evaluation module 38. The modules of the financial performance evaluating system 26 may be rearranged, combined, separated, or modified in other ways as needed to perform the functions disclosed herein without departing from the principles and scope of the present disclosure.

The income analyzing module 28 is configured to determine how much income is received throughout a reporting period (e.g., one year). Also, the income analyzing module 28 is configured to determine in which geographic regions associated with the different syndication markets the donors are located. In addition, income is analyzed to determine a category within which the income falls. For example, income can be determined to be Direct Income, Origin Income, and/or Motivation Income, as explained in more detail below.

The donor analyzing module 30 is configured to determine information about the donors, such as mailing information, phone numbers, and other information. The donor analyzing module 30 may be configured to store a mailing list of the donors in the database 16. With address information (e.g., zip codes), the donor analyzing module 30 may associate each donor with associated designated market areas (DMAs) or other demographic regions. Furthermore, the donor analyzing module 30 may track the number of donors, the number of new donors, the number of active donors during a reporting period, and/or other statistics of the donor pool. In some embodiments, the income analyzing module 28 and donor analyzing module 30 may operate together to extract the donation data.

The syndication expense analyzing module 32 is configured to record the expenses or costs for purchasing syndication rights within various markets. In addition, the syndication expense analyzing module 32 may also be configured to determine mailing costs used to send letters to donors for soliciting additional income or to send donation receipts to the donors.

The demographic analyzing module 34 may be configured to analyze or receive information with respect to DMAs or other demographic regions, the number of people or households within each region, and other information regarding demographics. This information may be received from an external source, such as Nielsen Media Research.

The analyzing modules 28-34 are configured to retrieve, receive, gather, and determine the donor transaction information described above. In general, the donor transaction information comprises a Number of Active Donors, a Number of New Donors, Syndication Cost, the Market Size of the different syndication markets, Origin Income, and Motivation Income. In response to the donor transaction information, the normalization module 36 is configured to process the information to determine a number of financial performance metrics. The financial performance metrics may be calculated for each of the different demographic regions within which syndicated programs are available. The metrics may use the income per number of households in the demographic regions, the number of donors per number of households in the demographic regions, the average income per donor, the syndication cost per number of households in the region, return on investment (ROI), and other metrics that are configured to define the financial performance of the different demographic regions.

When the normalization module 36 has calculated the financial performance parameters, the results are provided to the evaluation module 38. The evaluation module 38 is configured to produce tables, graphs, or other format for presenting data to a user, thereby allowing the user to view and analyze certain trends, factors, anomalies, etc. In some embodiments, the evaluation module 38 may be configured with algorithms for detecting the trends, factors, anomalies, etc. From the analysis using these algorithms, the evaluation module 38 may be further configured to present the results to a user and also make recommendations. The recommendations may be related to increasing or maintaining syndication expenses in successful markets and/or decreasing or eliminating syndication expenses in unsuccessful markets.

The income analyzing module 28 and donor analyzing module 30 may be configured to determine which donors are exposed to which outlets. To achieve relatively accurate data, the syndicated programs may be produced with slightly different versions of phone and/or address information for receiving donations. The income analyzing module 28 may then tag every incoming transaction with a code number, and distinguish which phone number, address, PO Box number, and/or Web address was used for each transaction. By tagging the particular contact information that the donor used to make the donation, the income analyzing module 28 may determine which outlets the donors were exposed to. Moreover, the donor analyzing module 30 may be configured to record each donor's address (since a receipt may be mailed to the donor). The demographic analyzing module 34 may use the ZIP Code of donors to determine which local market the donors are in.

The income analyzing module 28 marks which dollars are from which outlet and the demographic analyzing module 34 may then extract the information associated with the outlets and markets. The normalization module 36 may manipulate this data using logic that provides a picture of how each outlet is performing. The evaluation module 38 may determine why each outlet performs as it does and may be used to make decisions and/or recommendations regarding how syndication costs can be modified if necessary.

For a non-profit organization, revenue from a media outlet usually comes in two ways. First, the program itself raises money, usually via an 800-number, PO Box, or Web address, referred to hereinafter as “Direct Income.” The media production company may then attempt to build a long-term relationship with the donor via a Direct Mail program. Since the long-term value of a donor is typically tilted towards their mail responses, it may not be necessary for the program to “pay for itself” with the Direct Income. If the programs attract a sufficient number of new donors, these donors may eventually become Direct Mail donors and pay for the program via Direct Mail fundraising. Nevertheless, the Direct Income may also be a useful income stream for subsidizing donor acquisition.

This leads to a distinction between the Direct Income the programming is bringing in on “day one” versus the income over time from donors brought to the organization by the media outlet. More details are discussed below regarding distinguishing between and measuring of these two income streams.

In the meantime, it is noted that these two types of income streams are not restricted to the non-profit realm. In a for-profit venture, a TV program might attract Direct Income but it may also create loyal or repeat customers, whose income stream over time may likely be larger than the “day one” Direct Income. However, some businesses (for example, subscription businesses like Pay-TV or magazines) may not focus on the Direct Income but may be more interested in the long-term value. The decision making process described below applies to these situations as well.

Focusing on the TV medium in a country (e.g., the United States), one challenge is to determine which donors are viewing which outlet. There are two basic types of outlets: national outlets (network channels carried by cable systems, such as Discovery Channel or TBN) and local outlets (network affiliates or independent stations that broadcast only in one area, such as WSVN, the Fox affiliate in Miami).

National networks potentially reach any area of the country. For national networks, the tracking technique is to create a unique version of the TV program for each network (or family of networks) that has a unique 800-number, PO Box, and Web address. As donors contact the media production companies, the demographic analyzing module 34 may be configured to determine which 800-number, PO Box, or Web address the donors have used, and thereby determine which national network they were watching.

Although it may be difficult, the demographic analyzing module 34 may use this technique for local outlets even though there are many of them. Fortunately, the current regulatory environment simplifies this process. Nielsen Media Research has divided the US into 210 demographic regions known as Designated Market Areas or DMAs. Each TV station that has a high-power license in a particular market is required by the FCC to be carried by all of the cable outlets and by all of the satellite outlets (if they carry any local channels) in that DMA. For purposes of analytics, this “compartmentalizes” TV purchases so that each local high-power TV station that airs a program can be thought of as completely reaching its home DMA. Once it is determined which DMA the donor lives in, the demographic analyzing module 34 may determine which local TV station they are watching.

Nielsen Media Research defines each DMA by a list of counties. It may not be easy to determine which county each donor lives in, but Nielsen supplies a table that maps ZIP Codes into DMAs. This might not be perfect as some ZIP Codes lie in more than one DMA. Nevertheless, most ZIP Codes map to a single DMA and so this provides the most convenient way to tell which donor is in which DMA.

Thus, the demographic analyzing module 34 may use a single PO Box, 800 number, and/or Web address for the local outlets of the media production company. Then, the demographic analyzing module 34 may be configured to use the ZIP Code information (mapped to DMAs) to determine which specific local outlet the donor was watching.

In summary, the demographic analyzing module 34 may determine which local station and/or which national network each donor was watching. This in turn allows the financial performance evaluation system 26 to measure the quality and quantity of donors contributing to the organization by each TV outlet. (In for-profit implementations, it would allow the system 26 to measure the quality and quantity of repeat customers brought to the business by each TV outlet.)

As already noted, non-profit fundraising may have many facets. In order to evaluate each method of fundraising used by the organization, the income analyzing module 28 may mark each transaction with a “Motivation Code” that essentially explains why each donation was made. For example, a check sent in reply to a Direct Mail piece may be given a Direct Mail Motivation Code, and a credit card transaction via the 800-number for a TV program may be given a TV Motivation Code.

There is typically a unique Motivation Code for each program and/or each Direct Mail piece. To allow summarized reporting, Motivation Codes roll up into Motivation Categories. The Motivation Codes for every week for one TV outlet fall under a single Motivation Category. Thus, the income analyzing module 28 may summarize the Direct Income for a TV outlet by adding up the dollars associated with its Motivation Category.

The donor analyzing module 30 may be configured to give each new donor an Origin Code when the donor makes his/her first gift. This Origin Code is related to the Motivation Category of their first gift. For instance, if their first gift was to the 800-number for a TV outlet, the donor analyzing module 30 gives the donor the Origin Code for that TV outlet. This allows the financial performance evaluation system 26 to track over time the donating behavior of donors who were introduced to the organization by that TV outlet. In a for-profit embodiment, the Motivation Code may be related to the reason for each purchase and the Origin Code may be related to the reason for their first purchase.

The income analyzing module 28 may tag every transaction that comes in by a Motivation Code. For TV, the Motivation Category behind the specific Motivation Code is linked to the 800-number, PO Box, or Web address used by the donor to make the donation. If this is the first donation from this donor, the income analyzing module 28 and/or donor analyzing module 30 may also note the Origin Code of this donor. Since a receipt is typically sent to the donor, the donor analyzing module 30 may record the donor's mailing address. From the donor's ZIP Code, the demographic analyzing module 34 may determine which DMA they live in.

The income analyzing module 28 may tabulate the income for each media outlet in at least two ways. The first designation is “Origin Income,” which is the ongoing income from the donors who were first brought to the organization by that outlet. At a minimum, it may be the case that there is enough Origin Income to pay the cost of the outlet (recognizing that this might take time for a new outlet). The income analyzing module 28 may find this number by adding the income from the donors with a certain Origin Code.

The income analyzing module 28 may designate some income as “Motivation Income,” which is the income each week that comes directly from the program itself via its 800-number, PO Box, and/or Web address. This is also known as the Direct Income for that outlet. The income analyzing module 28 may find this number by adding the income from the transactions associated with the Motivation Category for that outlet.

These two categories are not mutually exclusive. Some of the Motivation Income for an outlet may be from donors whose Origin Code is from that TV outlet, which may be the case for some new donors. However, since TV donors typically become Direct Mail donors, over time the Origin Income may likely overtake the Motivation Income. The reality is that both of these are useful metrics. Motivation Income indicates what the outlet is worth now and Origin Income indicates the long-term value of the outlet. These concepts may also apply just as well to for-profit entities.

While income is a useful metric, it typically varies based on the size of the market. One way to compare two markets against each other is to use metrics that are scaled by the size of the market. This process is called “normalization.” The normalization module 36 is configured to scale the metrics based on the number of households (e.g., TV household) in each market.

At the end of a reporting period (e.g., the end of an organization's fiscal year), the financial performance evaluating system 26 may total the numbers and run reports. The income analyzing module 28 may be configured to sum the numbers by Origin Code and Motivation Category and the demographic analyzing module 34 may be configured to break the numbers down by DMA. The totals of the income, number of donors, and syndication costs for each demographic region are calculated or recorded for the reporting period. These totals may be stored in the database 16 for analysis by the normalization module 36 and evaluation module 38 as needed. The normalization module 36 receives metrics, such as by retrieving the valid information from the database 16, and processes the metrics to evaluate the media outlets.

Nielsen Media Research publishes the number of TV Households (TV HH) in each of the 210 DMAs. Each local TV outlet can be assumed to reach all of the TV HH in their home market. Each national network publishes a “reach” number of the number of TV HH reached by that network. In either case, the normalization module 36 may divide the income (and cost) numbers for each outlet by the number of TV HH to get normalized income (and cost). It should be noted that since the income and costs tend to be smaller numbers than the number of TV HH, it may be convenient to perform the calculations per thousand TV HH.

The normalization module 36 may also compare the income directly with the cost. Income divided by cost is usually referred to as “Return on Investment” or ROI. The system may look at the cost divided by the income as the “breakeven period” for an outlet: the length of time needed to earn the income for covering the cost.

The metrics may typically be calculated over a period of time known as the Reporting Period. For example, the financial performance evaluation system 26 may run the report for the most recent 12 months and for the 12 prior months. Because non-profit fundraising may have significant seasonal swings, month-to-month or even quarter-to-quarter comparisons might be problematic. Thus, a yearly report may be preferred in this case. However, in some embodiments in which seasonal swings are less severe, reports may be processed for quarterly periods or monthly periods. Income and cost numbers may be totaled for the Reporting Period. Each metric (e.g., each Motivation Category and Origin Code) may be calculated for each different outlet. These numbers may be represented in the columns of a table. The metrics may be calculated for each individual DMA (where donors are mapped to DMAs by ZIP Code information). These numbers may be represented in the rows of the table. According to some implementations, the DMA metrics may be weighted by the normalization module 36 more for local TV outlets than for national networks.

The normalization module 36 may utilize a computer program (such as a SQL query) to extract information directly from the database 16. The following primary metrics are the “raw numbers” that are then used by the normalization module 36 to calculate the normalized metrics. The Origin Donors metric represents the number of donors with the Origin Code for that outlet (throughout the Reporting Period). The Active Origin Donors metric represents the number of Origin Donors who have given a gift during the duration of the Reporting Period. The New Origin Donors metric represents the number of Active Origin Donors whose first gift to the organization was during the Reporting Period. The Origin Income metric represents the total income from the Origin Donors through the various venues during the Reporting Period. (Origin Income may include income from the Direct Mail stream, for example.) The Motivation Income metric represents the total income for the Motivation Category for this outlet during the Reporting Period. (Motivation Income may be the TV income.) The Cost metric represents the total cost for the Media Outlet for the Reporting Period. The TV HH metric represents the number of TV Households for each market during the Reporting Period. As previously noted, there is some overlap between the Origin Income and the Motivation Income.

The normalization module 36 manipulates the primary metrics into a suite of derived metrics or normalized metrics. In some embodiments, for example, the results may be presented on a spreadsheet. The following are some of the normalized metrics that may be calculated by the normalization module 36.

An Income Per Thousand TV HH (IPM) value may be calculated by the equation:

$$IPM = \frac{Origin Income}{TV HH} \cdot 1 \text{,} 000$$

The IPM value is based on the total income from the donors brought to the organization through this media outlet and it is normalized relative to the size of the market.

A Donors Per Thousand TV HH (DPM) value may be calculated by the equation:

$$DPM = \frac{Active Origin Donors}{TV HH} \cdot 1 \text{,} 000$$

The DPM value represents the donor penetration (e.g., the quantity of donors relative to the size of the market).

An Income Per Donor (IPD) value may be calculated by the equation:

$$IPD = \frac{Origin Income}{Active Origin Donors}$$

The IPD value is the total amount given per Reporting Period per donor, or the quality of donors. It may be noted that:

IPM=DPM·IPD

IPD and DPM are the two components of IPM. If a market has poor IPM (low income), it may be because the IPD is low (each donor in that market is giving a low amount of money), the DPM is low (there are a low number of donors relative to the size of the market), or both.

A Cost Per Thousand TV HH (CPM) value may be calculated by the equation:

$$CPM = \frac{Cost}{TV HH} \cdot 1 \text{,} 000$$

CPM is the cost of the outlet (market) relative to the size of the outlet. This is an industry-standard term.

A Return On Investment (ROI) value may be calculated by the equation:

$$ROI = \frac{Origin Income}{Cost} = \frac{IPM}{CPM}$$

The ROI, based on the Origin Income, looks at the outlet in terms of the active donors that the outlet brings in.

A Net Per Thousand TV HH (NPM) value may be calculated by the equation:

$$NPM = \frac{Origin Income - Cost}{TV HH} \cdot 1 \text{,} 000$$

NPM is the Net Income relative to the size of the market. ROI is the ratio of income to cost while NPM is based on the difference of income and cost.

A Gross Donor Acquisition Cost (DAC) value may be calculated by the equation:

$$DAC = \frac{Cost}{New Origin Donors}$$

DAC tells how much it costs to acquire each new donor (implicitly assuming that the whole cost of syndication is expended on donor acquisition).

A Direct Income Per Thousand TV HH (Direct IPM) value may be calculated by the equation:

$$Direct IPM = \frac{Motivation Income}{TV HH} \cdot 1 \text{,} 000$$

Direct IPM tells the Direct Response income relative to the size of the market.

A Direct Return On Investment (Direct ROI) value may be calculated by the equation:

$$Direct ROI = \frac{Motivation Income}{Cost} = \frac{Direct IPM}{CPM}$$

Direct ROI tells the ratio of the Direct Income to the cost.

A Net Donor Acquisition Cost (Net DAC) value may be calculated by the equation:

$$Net DAC = \frac{Cost - Motivation Income}{New Origin Donors}$$

Net DAC is based on the cost as “subsidized” by the Direct Income. If the media buy is considered purely as an investment in new donors, then the Direct Income may be considered as a subsidy towards the cost of those donors. The Net DAC is the cost per new donor as subsidized by the Direct Income from that outlet.

A New Donors Per Thousand TV HH (New DPM) value may be calculated by the equation:

$$New DPM = \frac{New Origin Donors}{TV HH} \cdot 1 \text{,} 000$$

New DPM gives the number of new donors relative to the size of the market. Fundamentally, it tells the rate at which new donors are acquired.

A New Donor Income Per Thousand TV HH (New IPM) value may be calculated by the equation:

New IPM=New DPM·IPD

New IPM is a measure of the expected income from new donors. This metric assumes that all new donors instantly start giving at the average level for all donors (IPD). In this sense, it may be an overestimate of new donor income. However, it may be a useful metric that combines the relative quantity of new donors with the relative value of each existing donor in the market. One can think of it as “full conversion” income.

A Gross Breakeven (BE) value may be calculated by the equation:

$$BE = \frac{DAC}{IPD}$$

The Gross Breakeven (measured in years) is the gross cost to acquire each new donor divided by the expected annual income from each fully converted donor. This can be thought of as the number of years the media production company needs to acquire donors at the current rate (who give at the current rate) in order to pay for the outlet. Like “New IPM,” it is a rough measure because it implicitly assumes that every new donor immediately starts giving at the full giving level. The Gross Breakeven metric looks like an inverted ROI (Cost divided by Income), and in a sense, it is. But one difference is that “donors” in the numerator are new donors while the “donors” in the denominator are active donors. This metric makes the simplifying assumption that all new donors will give at the same level as existing active donors.

A Net Breakeven (Net BE) value may be calculated by the equation:

$$Net BE = \frac{Net DAC}{IPD}$$

The Net Breakeven (also measured in years) uses the Net DAC instead of the DAC, meaning that it looks at the cost as subsidized by the Direct Income. This single metric combines the cost, the Direct Income, the Origin Income, and the rate of acquiring new donors into a single metric. Net Breakeven may typically be proportionately better for markets that have better Direct Response.

The evaluation module 38 receives the values calculated by the normalization module 36 to evaluate each of the outlets during the reporting period. The slate of normalized metrics allows for direct comparisons between outlets of very different sizes. For every metric listed above, the evaluation module 38 may compute the national average of the metric across the organization's outlets. The evaluation module 38 may also “index” each of the outlet's metrics to the national average. This allows the system to determine which metrics are better than or worse than average for each outlet.

In a first example, the evaluation module 38 may be used to compare local outlets. The evaluation module 38 may use the results of the equations listed above to get detailed information as to the relative performance of a media production company's local markets. According to some embodiments, the size of the market may be defined, for example, as a “huge” city for a Top 10 market, a “large” city for a rank between 11 and 30, and a “small” market for a rank greater than 30. The numbers below represent actual data obtained during calendar year 2009 for a non-profit organization.

| | Huge | Large | Small |
|---|---|---|---|
| Primary Metrics | Market | Market | Market |
| DMA Population Rank | <10 | 10-30 | >50 |
| Active Origin Donors | 1,489 | 812 | 223 |
| New Origin Donors | 279 | 199 | 35 |
| Origin Income | $311,401 | $227,032 | $170,892 |
| Motivation Income | $30,712 | $56,429 | $6,774 |
| Cost | $86,580 | $74,880 | $5,525 |
| Television Households | >2M | 1-2M | <500k |

A few observations may be apparent from this table. The small market in this example has a large Origin Income compared to the size of the market, which may be because of the quantity or the quality of the donors. Also of interest is that the small market's Motivation Income is higher than its cost. Put simply, this market turns a profit on day one before any of the new donors start giving to Direct Mail.

The metrics listed in the table above are then inserted in the above equations. The results are shown in the table below. The leftmost column of the table shows the financial performance metrics. The three columns on the right portion of the table show “index” values of the markets against the national average for each metric. Using the normalization module 36, numbers in the above table were inserted in the appropriate equations to compute the numbers in the table below.

| Normalized | Huge | Large | Small | | Index | Index | Index |
|---|---|---|---|---|---|---|---|
| Metrics | Market | Market | Market | Average | Huge | Large | Small |
| IPM | $55.08 | $146.76 | $511.65 | $71.01 | 78% | 207% | 721% |
| IPD | $209.13 | $279.60 | $766.33 | $185.07 | 113% | 151% | 414% |
| DPM | 0.26 | 0.52 | 0.67 | 0.38 | 69% | 137% | 174% |
| CPM | $15.31 | $48.40 | $16.54 | $27.41 | 56% | 177% | 60% |
| ROI | 3.60 | 3.03 | 30.93 | 2.59 | 139% | 117% | 1194% |
| NPM | $39.76 | $98.35 | $495.11 | $52.75 | 75% | 186% | 939% |
| DAC | $310.32 | $376.28 | $157.86 | $236.21 | 131% | 159% | 67% |
| Direct IPM | $5.43 | $36.48 | $20.28 | $8.99 | 60% | 406% | 225% |
| Direct ROI | 0.35 | 0.75 | 1.23 | 0.49 | 72% | 153% | 249% |
| Net DAC | $200.24 | $92.72 | $(35.67) | $119.82 | 167% | 77% | −30% |
| New DPM | 0.049 | 0.129 | 0.105 | 0.077 | 64% | 166% | 136% |
| New IPM | $10.32 | $35.97 | $80.30 | $16.60 | 62% | 217% | 484% |
| BE | 1.5 | 1.3 | 0.2 | 1.7 | 90% | 81% | 12% |
| Net BE | 1.0 | 0.3 | — | 0.6 | 148% | 51% | 0% |

The normalized financial performance metrics provide values that may be evaluated by the evaluation module 38. The evaluation module 38 may present the values on a graph or any other suitable format to communicate the results to a user for analysis. It some embodiments, the evaluation module 38 may be configured to run algorithms for evaluating the results. The data may then be analyzed (either by human examination or by automatic processing by the financial performance evaluating system 26). As observed, the large and small markets have a higher-than-average Income per Thousand TV HH (IPM). The large market is higher because both the donor penetration (DPM) and the income per donor (IPD) are higher than average. For the small market, both metrics are above the national average and the IPD is four times the average. This means that this small market has an unusually high income because the donors themselves give an above-average amount (likely indicating a high percentage of major donors).

For the huge market, the income is in line with the national average, yet two metrics are interesting. The IPD is 15% above average while the donor penetration (DPM) is 30% below average. This market has fewer better donors than average, and the lack of quantity is cancelled out by the high quality.

The cost metric CPM show that the huge and small markets are cheap relative to their size while the large market is expensive relative to its size. The Donor Acquisition Cost (DAC) is very high for the larger markets and low for the small market. For the huge market, the DAC is high because the number of new donors (New DPM) is low. However, for the large market, the DAC is high because the cost is high.

The Direct ROI numbers are interesting, as the large market is above average and the small market greatly exceeds the average. As already noted, the small market has a Direct ROI that is higher than 1.00. The effect of this is that the net numbers for the large and small markets are better than the net numbers for the huge market.

The Gross Breakeven (BE) for the huge and large markets are somewhat better than average. This is due to low cost for the huge market and a combination of high donor acquisition and high per-donor value for the large market. For the small market, the factors line up to result in a stellar Gross Breakeven number. The Net Breakeven (Net BE) numbers are poor for the huge market (low Direct ROI), good for the large market (good Direct ROI), and zero or immediate (profit on day one) for the small market.

The information above may then be used to determine specific strategies for these markets. The huge market is acceptable at least because the cost is low. However, since many numbers for the huge market are not impressive, a price increase in this market would be an unlikely recommendation. The large market is expensive, but it too is acceptable because both the quantity and quality of new donors are above average as a result of analyzing the numbers for the large market, a reduction in costs in this market may be worth trying. The small market is extremely profitable. The evaluation module 38 may recommend that the organization keep the outlet because it is inexpensive and the other numbers are satisfactory. It may also be recommended to increase expenses in the small market.

For some networks, the breakdown by DMA may not be important, but other metrics may be more relevant. The table below shows the primary metrics for four example networks.

| | | | Outlet 3 | Outlet 4 |
|---|---|---|---|---|
| | Outlet 1 | Outlet 2 | (new) | (new) |
| Active Origin | 43,731 | 8,257 | 567 | 254 |
| Donors | | | | |
| New Origin Donors | 8,437 | 1,784 | 567 | 254 |
| Origin Income | $7,953,211 | $1,207,625 | $32,368 | $10,059 |
| Motivation Income | $1,004,651 | $242,754 | $46,924 | $17,859 |
| Cost | $1,951,825 | $527,475 | $157,500 | $67,575 |

The last two columns represent Outlets 3 and 4, which are new outlets (added since the start of the Reporting Period). For the new outlets, the numbers should be thought of as “To Date” values instead of values covering the entire Reporting Period.

When looking at Normalized Metrics for the networks, the “per TV HH” metrics may typically matter less, but the ROI and Breakeven metrics may be more applicable. While networks publish reach numbers that may be used to compute per-household information, in general the other metrics provide enough guidance to allow comparison.

In the example below for a media production company, two of the networks are new outlets and had only been active for five months when the report was run. For this reason, the Income per Donor (IPD) metric was multiplied by a factor of (12/5) to extrapolate the IPD for a whole year. This also means that the Breakeven (BE) numbers are extrapolated by the same factor, since BE is based on IPD.

| | | | Outlet 3 | Outlet 4 |
|---|---|---|---|---|
| | Outlet 1 | Outlet 2 | (new) | (new) |
| IPD | $181.87 | $146.25 | $137.01 | $95.05 |
| ROI | 4.1 | 2.3 | 0.2 | 0.1 |
| DAC | $231.34 | $295.67 | $277.78 | $266.04 |
| Direct ROI | 51% | 46% | 30% | 26% |
| Net DAC | $112.26 | $159.60 | $195.02 | $195.73 |
| BE | 1.27 | 2.02 | 2.03 | 2.80 |
| Net BE | 0.62 | 1.09 | 1.42 | 2.06 |

Even though the organization had a program on the two new outlets for only five months, the numbers show that the Donor Acquisition Cost (DAC) is in line with the two established outlets. However, the Direct ROI is lower, which is interesting because it lengthens (worsens) the Net Breakeven. It is not clear why the Direct ROI is lower on the two new outlets. Taken at face value, it would seem to indicate that it takes time for viewers on a newly launched outlet to warm to the program enough to contribute.

Given that these two new outlets are only 5 months old, they appear to be performing well. While Outlet 3 is performing better than Outlet 4, the numbers for Outlet 4 (while worse than average) still seem acceptable for a new outlet.

Turning to the other two outlets, it may be seen that the Origin Income is far larger than the Motivation Income, which is the true hallmark of an established outlet. Outlet 1 is better than Outlet 2, but Outlet 2 has solid performance on its own.

Again, the financial performance evaluating system 26 may use the information in the above example to define specific strategies for the networks. Outlet 3 may be considered to be acceptable with respect to IPD, DAC, and BE and might therefore be recommended for continuation. The performance of Outlet 4 suffers from a low IPD. For a brand new outlet, the low IPD is not surprising but it may necessitate critical observation over time. When these outlets are to be considered for renewal, the evaluation module 38 may determine that both of them should be renewed but may also determine that a cost reduction might be considered for Outlet 4.

Outlet 1 may be considered to be an excellent performer and Outlet 2 may be considered to be acceptable. Outlet 2's lower IPD indicates that the donors acquired through that outlet do not contribute at the pace of Outlet 1. This lower IPD in turn pulls down the other metrics. But the IPD is close enough to merit maintaining Outlet 2 (although a cost reduction may be warranted).

These metrics allow for direct comparison between local channels even if the markets they serve are of different sizes. The financial performance evaluating system 26 may be a valuable tool that allows the user to consider the value of each outlet. The system 26 may help to provide answers that may be used to determine future syndication strategies.

The financial performance evaluating system 26 is configured to provide data that may help a user answer some of the following questions. Is it significant if our organization changes channels in a market? Is there a benefit in income or other metrics if we stay on a channel for a long time (or a negative difference for a newly changed channel)? All other things being equal, should our organization purchase air time from the major network affiliates, smaller networks, secular independent stations, or Christian stations? Does our syndicated program provide better financial results early in the morning, late in the morning, or in the evening? It is understood that answers to these questions may significantly influence an organization's buying decisions.

The answers to the above questions may depend on the results provided by the financial performance evaluating system 26. Although the following describes particular solutions, it should be understood that other logic, computer programs, and/or functions may be performed differently depending on the specific design.

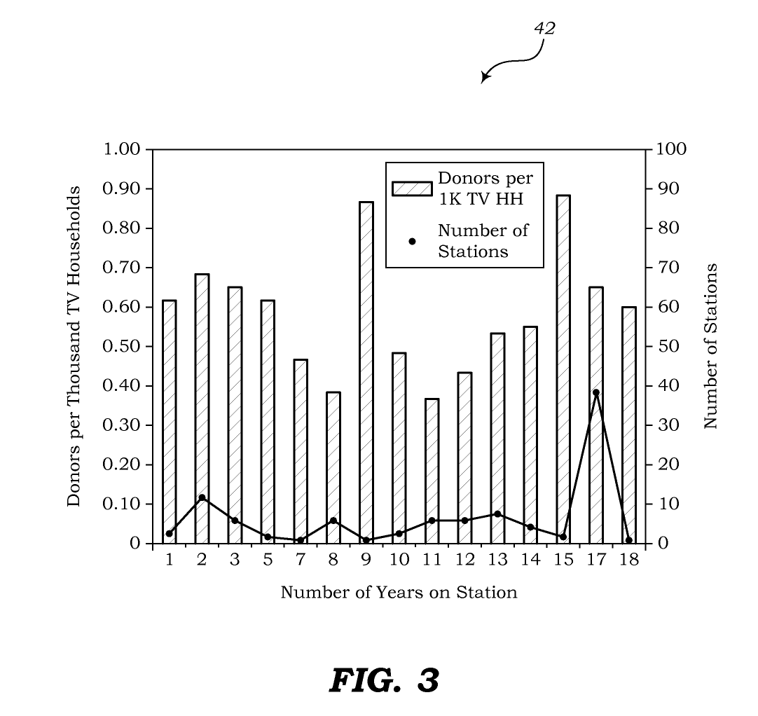

FIG. 3 is a graph 42 showing an example of data that may be examined to determine the significance of purchasing air time on the same station for a number of years. As illustrated, the graph 42 shows that staying with a station for more than a couple years may have little added impact. This may seem counter-intuitive, but the data appears to support this observation.

If time on a station is beneficial, it would be expected to increase either the quantity of donors (DPM) or the quality of donors (IPD). The system may consider the Income numbers and not the Cost numbers, since the Cost numbers depend on factors other than the time on the station. If it helps to be on a station a long time, it might show up in the income numbers, but probably not in the cost numbers.

The graph 42 averages the Donors per Thousand TV Households (DPM) based on the number of years that an organization has been on each local station in its portfolio of about 100 local stations. In FIG. 3, the DPM, or donor penetration, is considered. There is a “spike” in the number of stations at year 17 due to an artifact of how the organization keeps its contract information. In this case, the organization had launched a new contract system 17 years earlier.

The thing that may be noticed is that the number of donors does not change significantly over time. There are spikes at years 9 and 15, but the number of stations is low for these years, which may suggest that the spikes may be due to those few specific stations. From analysis of the graph 42, it may be determined that there are no clear trends. The reason for this observation may be due to attrition (i.e., the average donor tends to contribute to an organization for about three years). While donors may be on file for much longer than three years, many may discontinue making donations after a few years. This means that organizations normally need to be constantly acquiring and establishing relationships with new donors. This, in turn, means that a media buy is going to reach equilibrium within a few years, such that as many donors from that outlet are leaving (“attrition”) as are being acquired. (In fact, the decline in donor penetration in years 3 through 8 in the above example may be due to the fact that the organization had “saturated” those outlets and are no longer bringing in enough new donors to cover attrition.)

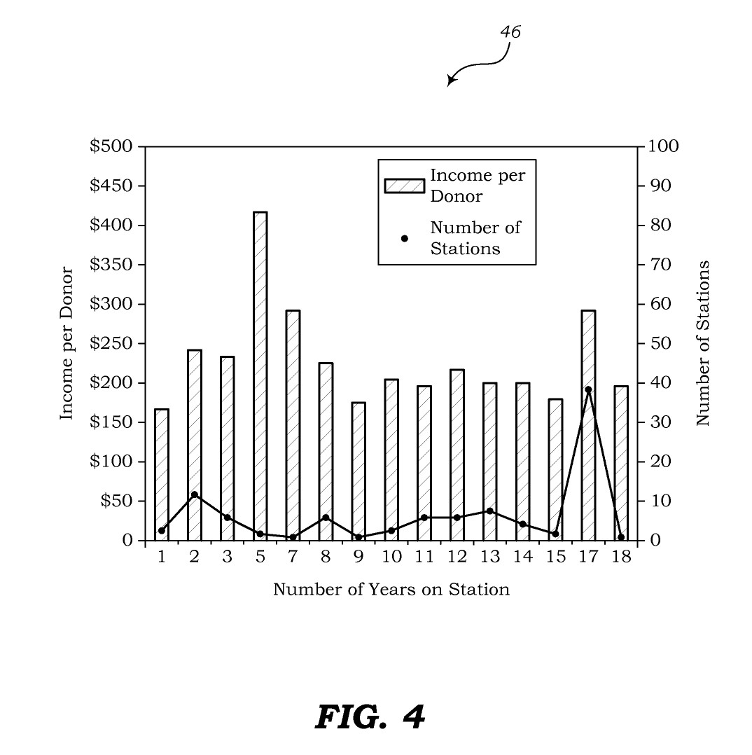

FIG. 4 is a graph 46 showing an example of income data obtained with respect to the related stations maintained over a number of years. In this graph 46, the data may also be examined to determine the significance of purchasing air time on the same station for a number of years. The graph 46 shows Income per Donor (IPD). Again there does not seem to be a clear trend, other than the arbitrary spike at Year 5. The stations that the organization bought 5 years earlier were apparently a good buy. It may be noticed, though, that Year 1 shows a relatively lower performance. However, this may be expected since it typically takes some time for new donors to feel comfortable to give at their full level. What may not be expected is that the income per donor basically levels out in Year 2 and does not change from there.

Not only is attrition a factor for IPD, but there also may be the factor that TV might not be an organization's primary medium for donor income. The donor income may rely more heavily on Direct Mail. Between the attrition and the transition to Direct Mail, it is clear that time on a station may have less impact on IPD than on DPM.

The counter-intuitive result (i.e., that being on a station for more than a couple years normally does not help income) has a corollary: if an organization is paying too much for programming on a station, changing stations will not likely have negative results. If the company moves to a station that acquires 30% fewer donors but costs 50% less, the company will likely benefit financially.

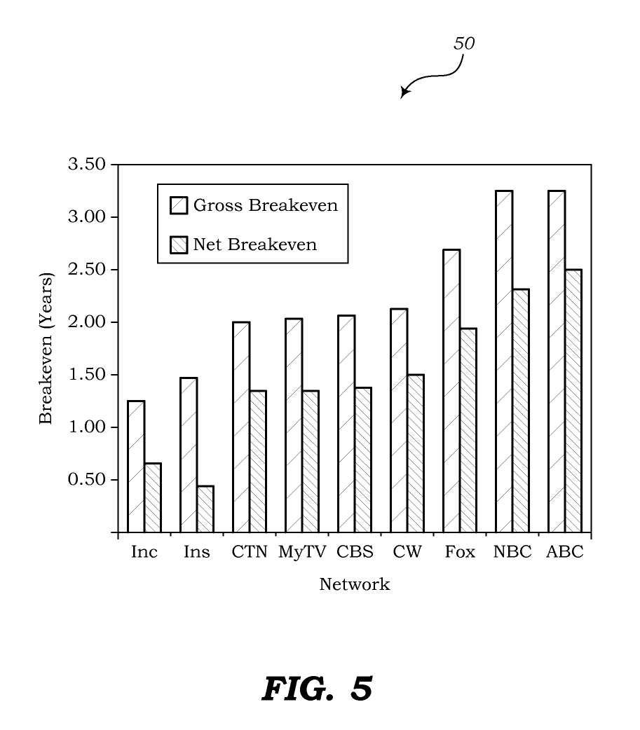

FIG. 5 is a graph 50 showing an example of values obtained for Gross Breakeven (BE) and Net Breakeven (Net BE) for purchasing air time on various network affiliations. For overall performance, the financial performance evaluating system 26 may consider the cost as well as the income. The reality is that the major TV affiliates (ABC, NBC, Fox, and CBS) in the United States (i.e., the “Big 4” affiliates) cost more because they have a higher viewership. However, it may not be worth the higher cost.

In the graph 50, a lower (faster) Breakeven is better and a higher (longer) Breakeven is worse. The network “Inc” represents Independent—Christian and “Ins” represents Independent—Secular. As illustrated in this example, the extra cost of the “Big 4” is not sufficiently countered by higher donor acquisition. Christian stations have the best Gross Breakeven and non-religious Independent stations have the best Net Breakeven, meaning that the Ins stations have a better Direct Response.

When an organization considers buying a new market, the evaluation module 38 may recommend networks based on the results of the graph 50 of FIG. 5. A first choice in this situation may be an Independent Christian station. Based on this data, executives of the organization may also feel comfortable moving from an expensive “Big 4” to a less expensive network in a local market.

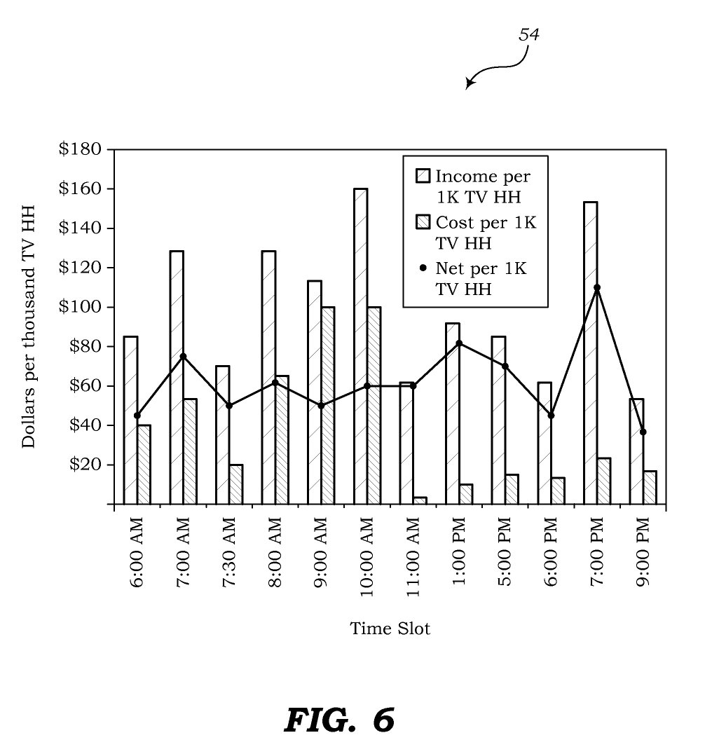

FIG. 6 is a graph 54 showing an organization's Income data with respect to Time Slots within which their programs are scheduled to air. Some factors involved in deciding which Time Slots to choose may be the income received and the cost to purchase air time during those Time Slots. For example, programs shown early Sunday morning (before 8:00 AM) have a moderate price. Mid-morning Time Slots (e.g., 8:00 or 9:00 AM) are expensive, and afternoon Time Slots are the least expensive. The evaluation module 38 may be configured to determine if it is worth the extra cost to air during the prime time slots.

The graph 54 of FIG. 6 shows Income per Thousand TV HH (IPM) and Cost per Thousand TV HH (CPM) as a function of Time Slot. For clarity, the graph 54 also shows the Net per Thousand TV HH (NPM), which is equal to CPM—IPM. This information should not be confused with the ROI value, which is equal to IPM/CPM.

An observation of the data seems to show that there is not a significant difference among the various time slots. The late morning and afternoon slots do not perform as well but are much cheaper. This decrease in cost may be due to the fact that non-religious stations may not be available past 11 am, and the 11 am and later time slots are on Christian stations.

However, this graph also shows that the evening slots do extremely well. When considering ROI (instead of Net), the evening time slots exemplify very good performance. The financial performance evaluating system 26 may analyze the data of FIG. 6 and recommend that the organization consider purchasing an evening time slot when time slots are to be added.

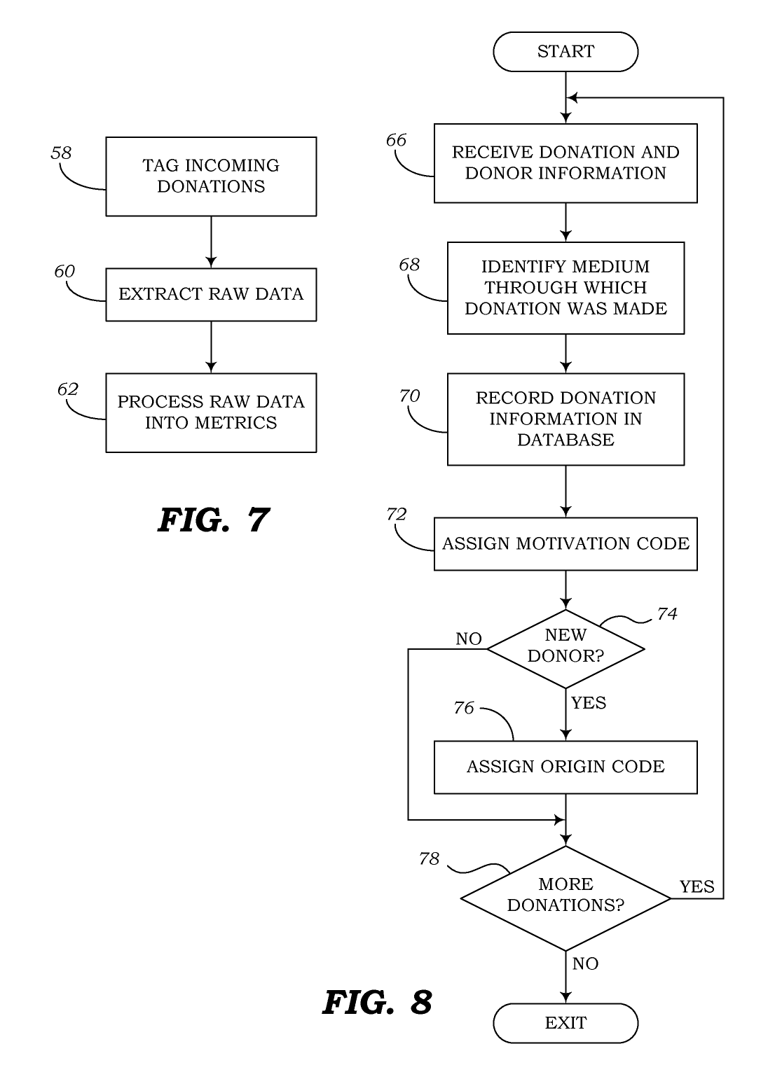

FIG. 7 is a flow diagram showing an embodiment of a method for managing donation information. For example, the method of FIG. 7 may include one or more functions of the financial performance evaluating system 26 of FIG. 2. According to the embodiment as illustrated, the method includes tagging incoming donations, as indicated in block 58. Tagging of donations may include categorizing the donations based on various factors, such as whether the donor is a new donor making a first gift, the medium through which the donor is making the donation, and other factors. It may be beneficial to tag the incoming transactions to identify which transaction came from which address, phone number, web site, or other contact method. This process may assign an appropriate code, such as a Mail code, Phone code, Web code, or other applicable codes, depending on the type of medium used to receive the donation. The process may be implemented as part of the workflow for entering transactions into the software used to manage the transactions.

After tagging the data, the method includes extracting raw bdata from the donations, as indicated in block 60. For example, extracting data may include determining categorization codes, totaling the income of gifts throughout the plurality of markets, calculating the syndication costs, determining the size of each market, and other processes. In some embodiments, extracting the donor data may include using a SQL stored procedure. The costs per market may be tabulated using software used to manage the media outlets, and the size of each market may be part of the data received from Nielsen (e.g., implemented in a spreadsheet).

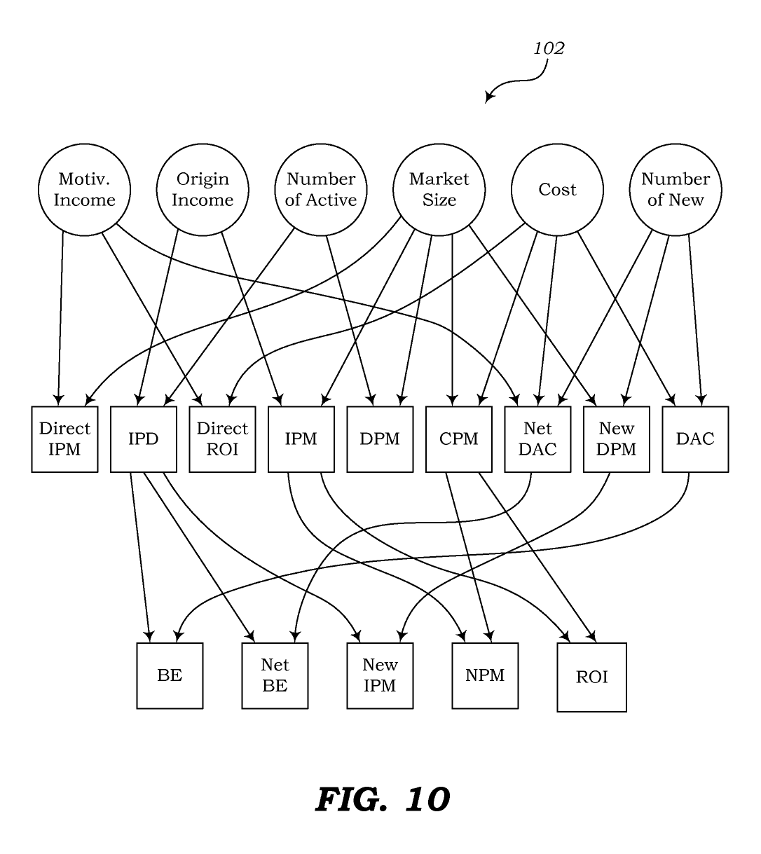

According to block 62, the method further includes processing the raw data into various metrics that may be used to define the financial performance of an organization in the different markets. In some embodiments, the output data file from the SQL stored procedure may be entered into a spreadsheet. This spreadsheet may also include the cost data for each market and the size of each market. The spreadsheet may be configured to combine several data elements, such as those shown in FIG. 10, and process these data elements into a plurality of metrics used to compare markets, make recommendations, and present results for helping executives make decisions. The equations described above with respect to the operations of the normalization module 36 shown in FIG. 2 may be used to compute the plurality of financial performance metrics. The comparisons, decision making, and/or recommendations may be performed by the evaluation module 38.

FIG. 8 is a flow diagram showing an embodiment of a method for tagging incoming donations. According to some implementations, the method of FIG. 8 may correspond to block 58 shown in FIG. 7. The method as illustrated in FIG. 8 includes receiving a donation from a donor and receiving information about the donor, as indicated in block 66. In block 68, the method is described as further identifying the medium through which the donation was made. For example, donations may be received by phone (e.g., an 800 number), by mail, by secure web site, by automatic withdrawal from a donor's financial institution, or by other means. The information included in the address, phone number, and other indicators may also help to identify what media outlets the donor was exposed to.

As indicated in block 70, the method includes recording the donation information into a database or other storage unit. As indicated in block 72, a Motivation Code is determined and assigned to the received donation. For example, the Motivation Code may be determined from the information gathered from the donor in the previous blocks. Decision block 74 indicates that a determination is made whether the donor is a new donor making a first donation. If so, the method proceeds to block 76. Otherwise, block 76 is skipped and the method jumps ahead to decision block 78. In block 76, the method includes assigning an Origin Code, which represents the medium and program that the new donor was exposed to leading the donor to give for the first time. As indicated in block 78, it is determined whether more donations are to be processed. If so, the method returns back to block 66 to repeat the steps for the next donation. If no more donations are to be processed, the method exits.

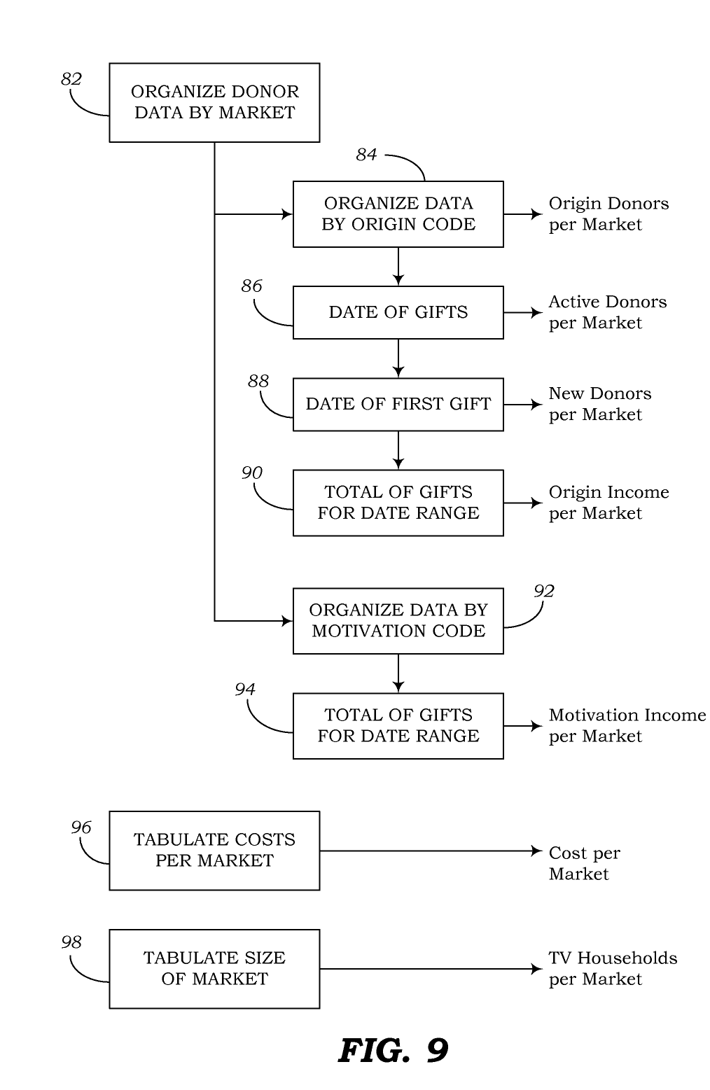

FIG. 9 is a flow diagram showing an embodiment of a method for extracting data from one or more donor transactions. As illustrated, the method of FIG. 9 includes a first set of processes for organizing donor data by market, as indicated in block 82. In some embodiments, the processes of organizing donor data may be performed by the donor analyzing module 30 shown in FIG. 2. As indicated in block 84, organizing donor data includes organizing data by Origin Code to determine the number of Origin Donors per Market. As indicated in block 86, organizing donor data further includes extracting the dates of the gifts to determine the number of active donors per market. As indicated in block 88, organizing donor data further includes extracting the dates of a donor's first gifts to determine the number of New Donors per Market. And as indicated in block 90, organizing donor data also includes determining the total amount of gifts made during the date range to calculate the Origin Income per Market. The method further includes organizing data by motivation code, which is indicated in block 92. According to block 94, the total amount of gifts for the date range is determined to calculate the Motivation Income per Market.

In addition to organizing donor data, the method of FIG. 9 further includes tabulating syndication costs per market, as indicated in block 96. In some embodiments, the processes of tabulating syndication costs may be performed by the syndication expense analyzing module 32 shown in FIG. 2. The result of the tabulation processes is a cost that is attributed to each market. Furthermore, the method of FIG. 9 includes tabulating the size of each market, as indicated in block 98. This process, for example, may be performed by the demographic analyzing module 34 shown in FIG. 2. By tabulating the size of the market, the number of TV households per market is calculated.

The extraction of the data may utilize specialized software and queries. Although the overall logic may be similar, the detailed query may be different for each Donor Management System and/or financial system. This query may be customized for each “make and model” of financial/donor management system currently in use in the industry.

FIG. 10 is a flow diagram 102 showing an embodiment of a method for processing donation data into metrics. The donation data may be received from various sources or calculated internally. The donation data may be derived by module 28-34 shown in FIG. 2 or by other modules for obtaining the relevant data. In some embodiments, the donation data may be obtained from the processes discussed with respect to FIG. 9. As illustrated in this embodiment, the donation data includes the variables shown within the circles at the top of FIG. 10. The donation variables include Motivation Income, Origin Income, the Number of Active Donors, Market Size, Cost, and Number of New Donors. According to various implementations, these and/or other variables may be obtained and utilized for calculating various financial metrics.

Further illustrated is a first layer of financial metrics (shown in the middle layer of FIG. 10) that are derived from the donation data. The financial metrics include Direct IPM, IPD, Direct ROI, IPM, DPM, CPM, Net DAC, New DPM, and DAC. According to various implementations, these and/or other parameters may be derived directly or indirectly from the donation data described above, such as by using the equations described with respect to the normalization module 36. Another layer of financial metrics are illustrated at the bottom of FIG. 10. These parameters include BE, Net BE, New IPM, NPM, and ROI and may be derived directly or indirectly from the donation data and/or from the middle layer of financial metrics.

The process descriptions or blocks in the flow diagrams of FIGS. 7-10 according to various implementations may represent modules, segments, portions of code, or other types of logic. The blocks may actually include one or more executable instructions for implementing specific logical functions or steps in the process. Some implementations may also be included within the scope of the embodiments of the present disclosure in which functions may be executed out of order from that shown or described, including substantially concurrently or in reverse order, depending on the functionality involved, as would be understood by those reasonably skilled in the art.

The processing of the data may use standard and/or specialized methods. Currently, the processing systems may be implemented using any desired spreadsheet, e.g., Excel, Crystal Reports, Web-based tools (displaying results on a Web page), or a customized application screen.

Because there may be 14 financial metrics for each market (e.g., the middle and lower layers in FIG. 10), one challenge might be the presentation of the data in a usable way. The following are some examples of methods for presenting reports by the financial performance evaluating system 26. In some embodiments, the reports may be provided by the evaluation module 38.

To enable a user to observe results for a single market, the reports may be color-coded to distinguish the metrics that are much better or much worse than average. In some embodiments, other techniques for highlighting the metrics may be used, such as using bold font, italics, special borders around cells of the spreadsheet, and/or other methods. Highlighting certain numbers may help the person viewing the reports to see at a glance the characteristics of markets or networks that stand out from the average numbers. This approach may be used in implementations of method for presenting reports such as those described above with respect to the evaluation module 38.

A software layer may be added to the system 26 to look at the variance of metrics from an average for a market and provide an automated market assessment that flags why the market is performing well (or poorly). In some embodiments, the system 26 may enable the user to scan across markets and see “Top 10” and “Bottom 10” lists for each metric. These reports may be useful for targeting which markets might need rate reductions due to low performance and which markets may be fine with a flat-rate renewal.

The system 26 may also provide a “what if” screen that shows what happens if the rate changes in a market. This, in turn, may be useful for evaluating new proposed rates when it is time to renew an agreement. The system 26 may also provide a “what if” screen for a brand new market to show what price levels and/or response levels would have to be met in order for the outlet to be viable. The system 26 may provide tables of data across the various markets, which in some embodiments may be exported to a spreadsheet, e.g., Excel. In the spreadsheet, the system may be configured to perform customized analyses of performance by time slot, time on station, network, etc.

By tagging the data, pulling and analyzing the results, and drawing conclusions, the financial performance evaluation system 26 may be configured to present analysis information and/or recommendations. This information may enable the organization to make informed decisions about its media buys. Paying for expensive time slots on expensive stations may not pay off for some organizations, and therefore the system 26 may allow the companies to spend their dollars more wisely.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

1. A financial performance evaluating computer system comprising:
a first analyzing module configured to determine an organization's donor income from donors within a designated market area;
a second analyzing module configured to determine the programming cost to air programs in the designated market area; and
a processing module configured to calculate one or more financial metrics based at least on the donor income and programming cost.

2. The financial performance evaluating computer system of claim 1, wherein the first analyzing module is further configured to determine a total amount of income during a reporting period and the type of media used by the donors to make donations.

3. The financial performance evaluating computer system of claim 1, further comprising a donor analyzing module configured to determine a number of new donors during a reporting period and a number of active donors during the reporting period.

4. The financial performance evaluating computer system of claim 3, further comprising a demographic analyzing module configured to obtain the number of households in the designated market area.

5. The financial performance evaluating computer system of claim 4, wherein the first analyzing module, second analyzing module, donor analyzing module, and demographic analyzing module are configured to obtain donation data from the group of donation information consisting of a Motivation Income total, an Origin Income total, a Number of Active Donors, the Market Size, a Cost, and a Number of New Donors.

6. The financial performance evaluating computer system of claim 5, wherein the processing module is configured to calculate at least one value from a group of values consisting of a Direct Income per Thousand Households (Direct IPM) value, an Income per Donor (IPD) value, a Direct Return on Investment (Direct ROI) value, an Income per Thousand Households (IPM) value, a Donors per Thousand Households (DPM) value, a Cost per Thousand Households (CPM) value, a Net Donor Acquisition Cost (New DAC), a New Donors per Thousand Households (New DPM) value, and a Donor Acquisition Cost (DAC) value.

7. The financial performance evaluating computer system of claim 6, wherein the processing module is configured to calculate the at least one value from the donation data.

8. The financial performance evaluating computer system of claim 6, wherein the processing module is further configured to calculate at least one metric from a group of metrics consisting of a Breakeven (BE) metric, a Net Breakeven (Net BE) metric, a New Income per Thousand Households (New IPM) metric, a Net per Thousand Households (NPM) metric, and a Return on Investment (ROI) metric.

9. The financial performance evaluating computer system of claim 8, wherein the processing module is further configured to calculate the at least one metric from the at least one value.

10. The financial performance evaluating computer system of claim 1, further comprising an evaluation module configured to graph the financial metrics based on the number of years the organization has bought air time on a number of stations.

11. The financial performance evaluating computer system of claim 1, further comprising an evaluation module configured to graph the financial metrics based on the number of years the organization breaks even on a number of networks.

12. The financial performance evaluating computer system of claim 1, further comprising an evaluation module configured to graph the financial metrics based on time slot during which the organization's programs are aired.

13. A computer-implemented method comprising:
determining return on investment (ROI) information for an organization based at least on the organization's income relative to cost to buy air time on a media outlet; and
presenting information to the organization to enable a determination as to whether the cost to buy air time on the media outlet is worth continuing.

14. The computer-implemented method of claim 13, further comprising tagging incoming donations to identify a medium through which the donations are made.

15. The computer-implemented method of claim 13, further comprising:
assigning a motivation code; and
assigning an origin code for donations made by new donors.

16. A computer program stored on a computer-readable medium, the computer program comprising:
logic adapted to extract at least income and cost information associated with an entity airing programs one or more media outlets; and
logic adapted to determine whether continuing to air programs on the one or more media outlets is warranted.

17. The computer program of claim 16, further comprising:
logic adapted to organize donor data by media outlet; and
logic adapted to obtain the size of each of the one or more media outlets.

18.-20. (canceled)
